(19) United States
(12) Patent Application Publication
(10) Pub. No.: US 2005/0119865 A1
(43) Pub. Date: Jun. 2, 2005

(54) Method for monitoring a technical system

(75) Inventor: Thomas Bartsch, Fellbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/997,354

(22) Filed: Nov. 24, 2004

(30) Foreign Application Priority Data
Nov. 25, 2003 (DE) DE 103 55 022.4

(51) Int. Cl. G06F 11/00

(52) U.S. Cl. 702/188

(57) ABSTRACT

The present invention relates to method for the model-based monitoring of a technical system. In a model of the defect-free system which describes the relationship in the defect-free system between an influenced variable y and an input variable u, a measuring inaccuracy for the measuring of y is determined. In a tolerance simulation, at least one model parameter is varied within a prescribed tolerance. In this way it is calculated how large the variation of the influenced variable y that is brought about by the parameter variation is. During the monitoring, the variation over time of the input variable u is fed both to the technical system and to the model. With the aid of the model, a reference variation over time of the influenced variable y is calculated. A narrow tolerance band and a wide tolerance band are placed around the calculated reference variation. If the measured variation over time lies outside the wide tolerance band, the technical system is classified as defective. If it lies within the narrow tolerance band, the technical system is classified as defect-free.

Priority is claimed to German Patent Application No. 103 55 022.4, filed on Nov. 25, 2003, the entire disclosure of which is incorporated by reference herein.

The present invention relates to a method for the model-based monitoring of a technical system.

### BACKGROUND

A technical system is monitored with the aim of detecting the occurrence of defects and unwanted states on the system and classifying the system as defect-free or defective.

A method for automatically monitoring a technical system is known from Rolf Isermann: “Modellgestützte Überwachung und Fehlerdiagnose technischer Systeme (Teil 1)” [Model-based monitoring and defect diagnosis of technical systems (part 1)], Automatisierungstechnische Praxis (atp) 38 (1996), issue 5, pages 9-20. The defect-free technical system is modeled by a linear multivariable model, that is, by a system of equations
X′(t)=Ax(t)+Bu(t) and y(t)=Cx(t),
where _(t) is the vector of the input variables, x(t) is the vector of the state variables, x′(t) is the first derivative of x(t) with respect to time and y(t) is the vector of the output variables. A, B and C are matrices. In this example, the output variables and the state variables are influenced variables. The input variables vector u(t) is fed on the one hand to the actual system to be monitored, on the other hand to the linear model. Various methods are disclosed for defining a variable that is influenced by the system and can be measured directly or indirectly. This variable depends on output, state and/or input variables. The variation over time of this variable is measured on the one hand. On the other hand, a reference variation is calculated with the aid of the model. The measured variation over time is compared with the reference variation, and it is decided whether the technical system is defect-free or defective.

A measured variation that deviates from the reference variation may be caused on the one hand by a defect on the technical system, but on the other hand merely by parameter tolerances and by inaccuracies in the measurement. In R. Isermann, loc. cit., it is not disclosed how defects can be distinguished from the tolerances and inaccuracies. Furthermore, the methods can only be used for linear models. However, many technical systems cannot be adequately described by linear models.

### SUMMARY OF THE INVENTION

An object of the present invention is to provide a method for automatically monitoring a technical system that takes into account in the monitoring, in a systematic way, the influence which the variations of parameters of the technical system within tolerances and the measuring inaccuracy exert on the measuring of the influenced variable.

The present invention provides a method for automatically monitoring a technical system (10), in which: at least one input variable that varies over time is fed to the system (10); the variation over time of at least one variable that is influenced by the system (10) is measured; the input variable is additionally fed to a model (20) which can be automatically evaluated and describes the relationship between the influenced variable and the input variable in the defect-free system (10); a reference variation over time of the influenced variable is calculated with the aid of the model (20); and the measured variation is compared with the reference variation; wherein: a tolerance is prescribed for at least one parameter of the model (20); at least one variation over time of the input variable is prescribed; a measuring inaccuracy for measuring the influenced variable is determined; the parameter is varied within the tolerance, the model (20) is stimulated with the variation of the input variable and a number of variations over time of the influenced variable resulting from the parameter variation are calculated with the aid of the stimulated model (20); a resultant variation of the influenced variable is determined from the variations generated with the aid of the parameter variation; a narrow tolerance band and a wide tolerance band are placed around the calculated reference variation; the width of the narrow tolerance band being equal to the resultant variation reduced by twice the measuring inaccuracy, and the width of the wide tolerance band being equal to the resultant variation increased by twice the measuring inaccuracy; the system (10) being classified as defect-free if the measured
variation always lies within the narrow tolerance band; and the system (10) being classified as defective if the measured variation lies outside the wide tolerance band at least for a time.

A model of the defect-free system is prescribed. This model describes the relationship in the defect-free system between an influenced variable and an input variable of the system and can be automatically evaluated by a computer. A tolerance is prescribed for at least one parameter of the model. The parameter may assume a value within this tolerance without the technical system being defective because of it. On the other hand, a value outside the tolerance is a defect.

A tolerance simulation is carried out. In this, the parameter is varied within the tolerance. At least one prescribed variation over time of the input variable is applied here to the model. As a result, the model is stimulated. With the aid of the model, a number of variations over time of the influenced variable that result from the parameter variation are calculated.

The varying of the parameter within the prescribed tolerance brings about an admissible variation of the influenced variable. With the aid of the tolerance simulation, it is calculated how large this admissible, brought-about variation is. During the monitoring of the technical system, this admissible variation has the effect that the variation of the influenced variable varies around the reference variation without a defect occurring.

Furthermore, a measuring inaccuracy for the measuring of the influenced variable is determined. A measured value of the influenced variable therefore coincides exactly with the actual value or is affected by a measuring error which is at most as large as the measuring inaccuracy. This measuring inaccuracy can lead to the effect that a measured value is further away from the calculated reference value than the actually existing value or else closer to the reference value.

During the monitoring, the variation over time of the input variable is fed both to the system and to the model. With the aid of the model, a reference variation over time of the influenced variable is calculated. A narrow tolerance band and a wide tolerance band are placed around the calculated reference variation. The width of the narrow tolerance band is equal to the resultant variation reduced by twice the measuring inaccuracy, and the width of the wide tolerance band is equal to the resultant variation increased by twice the measuring inaccuracy.

The measured variation over time is compared with the tolerance bands around the reference variation. If the measured variation over time is outside the wide tolerance band, it deviates from the reference variation, and consequently from the desired variation, in an inadmissible way, even if the measuring tolerance increases the deviation. The system is classified as defective. If the measured variation over time is always within the narrow tolerance band, it does not deviate at all from the reference variation, and consequently from the desired variation, or only in an admissible way, even if the measuring tolerance reduces the deviation. The system is classified as defect-free.

The method according to the present invention can be used for any technical system that can be described sufficiently accurately by a model available on computer. This model need not describe the technical system completely, but merely the relationship between the at least one influenced variable and the at least one input variable. The method can be used for static and dynamic technical systems, for example for those with state variables which vary over time.

By the method, the wide tolerance band and the narrow tolerance band are determined in a systematic, traceable, objective and reproducible way. The method has the effect that the technical system is classified as defect-free or defective while taking tolerance and measuring inaccuracy into account in a traceable, objective and reproducible way. This objectivity and reproducibility is important in particular whenever a company uses the method for monitoring a technical system and the technical system is supplied by a supplier. The method allows the customer and supplier to trace the classification procedure and result of the classification.

The method can be used on the one hand for time-limited functional testing of a system, for example in the case of incoming goods control of the system obtained from a supplier or quality control after manufacture. On the other hand, it can be used for monitoring a technical system while it is in operation.

For example, a number of parameter values lying within the tolerance are selected. The parameter is set to each of these values one after the other, and a variation over time of the influenced variable resulting from this value is calculated with the aid of the stimulated model. It is also possible for the parameter to be changed within the tolerance during a simulation run, that is for the stimulated model to be changed during a simulation run by varying the parameter within the tolerance.

The method may also to be used for a technical system with a number of input variables and/or a number of influenced variables. According to one alternative, two tolerance bands are placed around the respective reference variation for each influenced variable, that is a total of 2*n tolerance bands in the case of n influenced variables.

### BRIEF DESCRIPTION OF THE DRAWINGS

An exemplary embodiment of the present invention is described in more detail below on the basis of the accompanying drawings, in which:

FIG. 1 shows a block diagram of a testing device for carrying out an advantageous refinement of the method;

FIG. 2 shows the narrow tolerance band and the wide tolerance band;

FIG. 3 shows variations of an influenced variable p_a and of a controlled variable p_h in dependence on the parameter k;

FIG. 4 shows the determination of a parameter drift by comparison between the actual variation and a reference variation and

FIG. 5 shows an adaptation in the case of overshooting.

### DETAILED DESCRIPTION

The exemplary embodiment relates to the incoming goods control of a motor vehicle manufacturer. With the method according to the present invention, the latter checks component parts of motor vehicles. The method is performed at least once for each component part, the component part acting as the technical system. The component parts are manufactured by suppliers and supplied to a production line of the manufacturer. The manufacturer also checks component parts which are produced on a production line of the manufacturer and are subjected to a quality control with the aid of a testing system. An example of such a component part is an electrohydraulic control plate of an automatic transmission. The method can also be used by the supplier for his incoming goods control. Preferably, only the component parts that are classified as defect-free are delivered to the motor vehicle manufacturer, and the others are investigated more thoroughly.

The method can also be used for example for the monitoring of component parts of motor vehicles while the motor vehicle is in operation, for example as part of the control system of an automatic transmission.

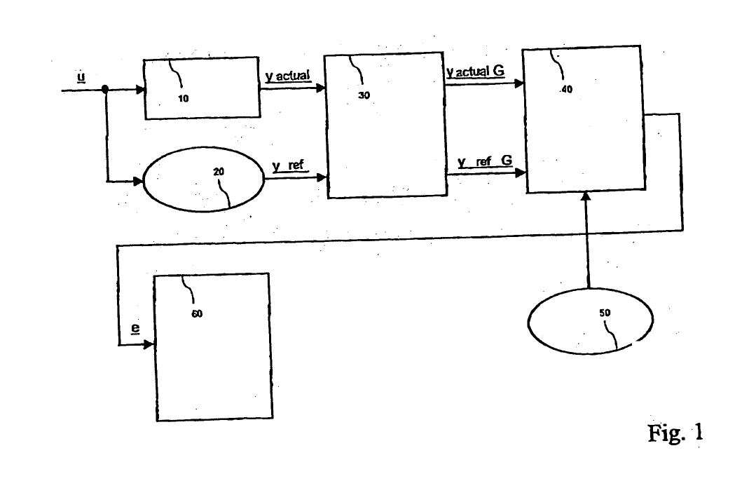

FIG. 1, described in more detail further below, shows a block diagram of a device which performs the advantageous refinement of the method according to the present invention that is described below. In this exemplary embodiment, m input variables lie at the component part 10 to be monitored and at the model 20, and the variations over time of n influenced variables are measured. The component part 10 is characterized by s1 parameters. The tolerances of the s1 parameters result in particular from unavoidable fluctuations of characteristic production variables and ambient conditions in the mass production of the component part 10. They are prescribed.

Typical examples of parameters of the component part 10 are characteristic variables of materials, for example the unit weight, the density, the viscosity, a spring constant, a friction coefficient, the thermal conductivity, the electrical conductivity or a characteristic of an electrical component, for example resistance, capacitance or inductance.

As long as the component part 10 is defect-free, the values of the s1 parameters of the component part 10 remain unchanged. A defect, on the other hand, can lead to an abrupt change of the value of a parameter, for example if a short-circuit occurs in an electrical line, or lead to a general drift of a parameter value, for example a gradual reduction of a spring constant.

By contrast with parameters, the m input variables and the n influenced variables change abruptly and/or gradually over time even when the technical system is defect-free, for example in the form of transient reactions.

In the example already mentioned of the automatic transmission with an electronic control system, the control system generates control signals in the form of currents. An electrohydraulic control plate as a component part of the transmission receives these control signals as input variables. Dependent on these signals, it generates pressures as output variables. These pressures activate the switching elements, i.e. the brakes and clutches of the mechanical transmission for gear selection. In the signal path of the control plate there are electrotechnical and hydraulic functional units. Among the parameters which characterize these functional units are the static transmission factor, the rise in the nonlinear characteristic curve at the operating point and/or the time constant of the functional unit.

A component part 10 investigated by the method is defective—even taking into account the tolerance and measuring inaccuracy—if the measured variation of at least one influenced variable lies outside the wide tolerance band. The component part 10 is then for example not installed in a motor vehicle but returned to the supplier. An investigated component part is defect-free if every variation over time of an influenced variable always lies within the reference band for this variable. If at least one variation lies outside the respective narrow tolerance band at least for a time and not all the variations lie outside the wide tolerance bands, the component part is investigated more thoroughly.

The method provides the motor vehicle manufacturer with a two-value classification result, that is defective or defect-free. The supplier of the component part is preferably provided with a multi-value result, which is used for troubleshooting. Apart from the two results just described, defect-free and defective, further possible results are provided for the case in which at least one variation lies outside the respective narrow tolerance band but not all the variations lie outside the wide tolerance bands. Which of the several possible results the comparison actually produces depends on the comparison between the measured variations and the reference variations. The supplier preferably assesses his production process from the actual results of comparisons for a number of component parts and discovers weaknesses and deficiencies in the production process that lead to the production of defective component parts.

For example, the supplier of the motor vehicle component part and the motor vehicle manufacturer use the results of the method as follows: the motor vehicle manufacturer assesses a component part as defective if a variation over time of at least one influenced variable leaves the wide tolerance band at least for a time, and otherwise he accepts it as defect-free. In his internal quality control, the supplier assesses the component part as defect-free only when every actual variation over time always lies within the respective narrow tolerance band.

The method steps are divided between two different phases, that is the generation phase and the classification phase. The steps of the generation phase are run through once for each component part type. At the end of the generation phase, the model 20 is obtained, and a resultant variation for each influenced variable. The steps of the classification phase are run through once for each component part to be monitored and produce the classification result and, whenever the component part is defective, preferably a statement about the defect or defects that is/are actually present on the component part.

Therefore, if two types of component parts are to be monitored and a thousand copies of each type are produced and all these two thousand copies are to be monitored, the steps of the generation phase are carried out twice and the steps of the classification phase are carried out two thousand times.

Any modeling method that leads to a model 20 which describes the relationship between the n influenced variables and the m input variables sufficiently accurately can be used for the method. The accuracy is adequate if the static and dynamic matching between the model 20 and the component part 10 are ensured.

Control-engineering and knowledge-based modeling methods are known from R. Isermann, loc. cit., from R. Isermann: “Identifikation dynamischer Systeme” [Identification of dynamic systems], volume 1 and volume 2, 2nd edition, Springer-Verlag, 1992, from R. Isermann: “Überwachung und Fehlerdiagnose-Moderne Methoden und ihre Anwendungen bei technischen Systemen” [Monitoring and fault diagnosis-modern methods and their applications in technical systems], VDI-Verlag, 1994 and from DE 197 17 716 C2 and EP 8 943 04 B1. In the first two publications, methods are disclosed both for the theoretical analysis and for the experimental identification of a technical system. A formal language by the name of “modelica” for modeling technical systems is described in Modelica Association: “Modelica-A Unified Object-Oriented Language for Physical System Modeling, Language Specification”, Version 2.0, available at http://www.modelica.org/doouments/ModelioaSpe020.pdf, visited on Oct. 31, 2003, and in M. M. Tiller: “Modelica-Introduction to Physical Modeling with Modelica”, Kluwer Academic Publ., 2001. An executable program is generated from a model in modelica by translation with the aid of a compiler.

A preferred modeling method comprises setting up for each type of component that is present at least once in the component part 10 a component type model which describes the output variables of the component in dependence on input variables and under some circumstances state variables or more generally the dependencies (“constraints”) between the variables of the component type. The component type model is valid for every component of the type, irrespective of its respective use. Furthermore, the interaction of the typified components in the component part 10 is described, in that the respective component type models are copied as often as there are copies of the respective type, and the copies are connected to one another. A component type is either described by a time-driven and continuous-value model or by an event-driven and discrete-value model. For the generation of a model 10, both types of component type models can be used.

A special kind of component type model is the description of the static behavior by characteristic curves (for one input variable) or characteristic areas (for a number of input variables). The characteristic curves or characteristic areas are approximated by interpolation nodes, between which interpolation is carried out. A switching element of the component part 10 that is used for triggering internal events in the system is modeled as switches realized by software in connection with an analog comparing element.

The dynamic behavior of the component part 10 is preferably described by differential equations. These differential equations are preferably likewise divided between the component type models. For example, a differential equation connects various variables of a component type to one another. Preferably, the characteristic curves or characteristic areas for the static behavior of a component type are arranged in series in the model by a differential equation for the dynamic behavior of this type. An example of such a differential equation is y+T*Y′=u, where T is the time constant of the component type, u is an input variable and y is an output variable.

For example, the component part 10 comprises three functional units arranged in series. The static behavior of each functional unit is described by characteristic curves or a characteristic area. If the time constants of the three functional units cannot be determined individually, preferably a sum time constant T_sum is determined for all three functional units. The dynamic behavior of the three functional units is described by the differential equation y+T_sum*y′=u. This differential equation is preferably added in the model of one of the three components.

It is also possible to summarize the dynamics of a subsystem in a virtual component type and to assign the differential equations which describe these dynamics to this virtual type. The static behavior of the subsystem is described by characteristic curves or characteristic areas, which are assigned to other component types that are represented in the subsystem.

If a theoretical analysis of the component part 10 as the technical system is not possible at all, or not within a reasonable time, there still remains the approach of training a neural network with a defect-free real component part 10. The trained neural network then behaves approximately in the same way as the real component part 10 and is used as the model 20.

The s1 parameters of the component part 10 as the technical system are described by s2 parameters of the model 20. It is possible that s1=s2. Preferably, all or at least some of the s2 model parameters are identical to parameters of the component part 10 and therefore have physical significances. The other model parameters are functions of parameters of the component part 10. The prescribed s1 tolerances for the s1 parameters of the component part 10 result in s2 tolerances for the s2 parameters of the model 20.

The desired values which the s1 parameters of the defect-free component part 10 have are obtained either from draft, design and/or production documents of the component part 10 or are obtained by a method of system identification, for example by measurements on real defect-free component parts 10 and a regression analysis. Methods for system identification and parameter estimation are known for example from R. Isermann: “Identifikation dynamischer Systeme”, loc. cit.

In a parameter estimation, the real and defect-free component part 10 as the technical system is activated by a control vector as the vector u of the applied input variables, and the influenced variables are measured directly or indirectly. In order to determine a suitable control vector, a structural analysis of the component part is carried out. With a structural analysis, the following information about the component part is determined:
the paths and couplings and operative relationships in the component part,
the interaction between analog and discrete components,
structural changeovers that are triggered by events.

The model 20 is preferably created in such a way that there is a unique relationship between the s1 parameters of the component part 10 and the s2 parameters of the model 20 and that changes of system parameters have an effect on influenced variables of the component part 10 and of the model 20. A parameter drift is reflected for example in the variation of the amplitude of an influenced variable or in a lead or lag of this variable over time.

With the method for system identification just described, a static nonlinear characteristic curve or characteristic area can also be determined and/or checked for plausibility. With such a characteristic curve or characteristic area, preferably some component types are modeled. A real defect-free component of the type is stimulated by a staircase-shaped input signal, and the signal response of the component is measured. Subsequently, the characteristic curve is approximated by a linear graph (polyline). Let u_l, . . . , u_r be the r interpolation nodes of this characteristic curve. The interpolation nodes produce the values of the staircase-shaped input signal. Let y_l be the value which the component produces after the input variable has been set to the value u1 and the transient reaction has subsided. For I=2, . . . r, let y_l be the value which the component produces once the input variable has been changed over from the value u_(i−1) to the value u_i and the transient reaction has subsided. The linear graph is defined by the r points
(u_l, y_l), . . . , (u_r, y_r).

“Tolerance” is understood as meaning the size of the allowed deviation from a prescribed desired value. In this way, the tolerance limits the range of values within which the parameter may vary admissibly, that is without a defect being present.

The prescription of a tolerance leads to an admissible range of values of the parameter in the form of an interval of which the two limits have, for example, the form
desired value−Δand desired value+Δ, with Δ>0 being prescribed, or,
r1 *desired value and r2 *desired value, with 0<r1<1 and r2<1 being prescribed.

It is also possible that the admissible range of values of a parameter is the interval [a, +∞) or (−∞, b].

The following table shows an example of a parameter variation. In this example, three parameters P1, P2 and P3 are varied. In the test plan, the desired value of the parameter is identified by 0, the smallest admissible value by−and the greatest admissible value by+.

| Combination No. | Parameter P1 | Parameter P2 | Parameter P3 |
|---|---|---|---|
| 1 | 0 | 0 | 0 |
| 2 | 0 | 0 | − |
| 3 | 0 | 0 | + |
| 4 | 0 | − | 0 |
| 5 | 0 | + | 0 |
| 6 | − | 0 | 0 |
| 7 | + | 0 | 0 |
| 8 | 0 | − | − |
| 9 | 0 | + | + |
| 10 | − | 0 | − |
| 11 | + | 0 | + |
| 12 | − | − | 0 |
| 13 | + | + | 0 |
| 14 | − | − | − |
| 15 | + | + | + |

Preferably, a time period in which the component part 10 is to be tested and/or to be monitored, and N sampling times t_{—}1, . . . , t_N in this monitoring time period are also prescribed. In the classification phase, the variations over time of the n influenced variables within this monitoring time period are measured, in that at each sampling time the n values of the n influenced variables are measured. The monitoring time period is on the one hand long enough that meaningful variations over time are measured, on the other hand short enough that the parameters of the component part 10 remain constant, or at most vary by negligible amounts, during the monitoring time period.

For the generation phase, at least one variation over time of each input variable is prescribed. The model 20 is stimulated by these m variations of the m input variables. Preferably, the variations are designed in such a way that all the operating points to be expected while operation is in progress and all the subsystems of the component part 10 are activated. For these r variations and for each of the M parameter combinations, a simulation is carried out with the aid of the model 20. In the above example of a test plan, these are M=15 parameter combinations and consequently M=15 simulations for each of the prescribed variations. A variation over time of each influenced variable is calculated by each simulation. Such a variation over time comprises the N values of the influenced variable at the N sampling times. Consequently, M values are calculated for each of the n influenced variables, for each of the r prescribed variations of the input variable and for each of the N sampling times. A resultant variation is determined for each sampling time and for each influenced variable with the aid of a statistical method. For a sampling time t_k (k=1, . . . ,N), let y_{—}1 (t_k) I . . . , y_M (t_k) be the M values at the sampling time t_f for the M parameter combinations. The mean value y (t_k) and the empirical dispersion Sₓ of these M values is calculated, with the empirical dispersion being calculated according to the calculating rule.

$${S}_{{x}^{2}} = \frac{1}{M - 1} {\sum }_{i = 1}^{M} {[ y\_i ( t\_k ) - \overline{y} ( t\_k ) ]}^{2}$$

An alternative embodiment of this envisages calculating the desired value y(t_k) of the influenced variable in that each parameter of the model 20 receives its respective desired value and then the simulation is carried out. The dispersion is calculated with the desired value y(t_k) instead of the empirical dispersion y (t_k), to be precise according to the calculating rule.

$${S}_{{x}^{2}} = \frac{1}{M} {\sum }_{i = 1}^{M} {[ y\_i ( t\_k ) - y ( t\_k ) ]}^{2}$$

Let Φ be the distribution function of the standard normal distribution, and q(1−α) be the one-sided (1−α) quantile of the distribution function Φ. The quantile q(1−α) is therefore defined such that: Φ[q(1−α)]=1−α. If, for example, α=2%, then 1−α=0.98 and q(1−α)=2.0537, since Φ(0.98)=2.0537.

As the resultant variation for the sampling time t_k, preferably the width of a (1−α) confidence interval about the mean value y(t_k) is used. This confidence interval has the lower limit y(t_k)−q(1−α)*Sₓ and the upper limit y(t_k)+q(−α)*Sₓ. The resultant variation is accordingly 2*q(1−α)*Sₓ. This variation depends inter alia on the sampling time.

A further alternative embodiment envisages using as variations that are brought about the difference between the greatest value and the smallest value of the influenced variable at the sampling time t_K (k=1, . . . ,N).

For each influenced variable y, a measuring inaccuracy U(y) for measuring the variable y is also determined in the generation phase. In the simplest case, that measuring inaccuracy which the manufacturer of the measuring instrument guarantees is used. However, it is also possible that the variable y is measured by a system with a number of instruments, for example a clamping device and a position measuring machine. In another embodiment, a combined standard inaccuracy u(y) is calculated in that the inaccuracies of all the components of the measuring instrument and the measuring method are squared, the sum of the squares is formed and the root from the sum of the squares is subsequently formed. The inaccuracies of the
measuring instrument and of the measuring method include, for example, the testing process, the testing means, the receiving device for the component part and the surroundings. U(y) is preferably the product of u(y) and a prescribed expansion factor k>1. The measuring inaccuracy typically lies at 10% to 20% of the resultant variation of the influenced variable y.

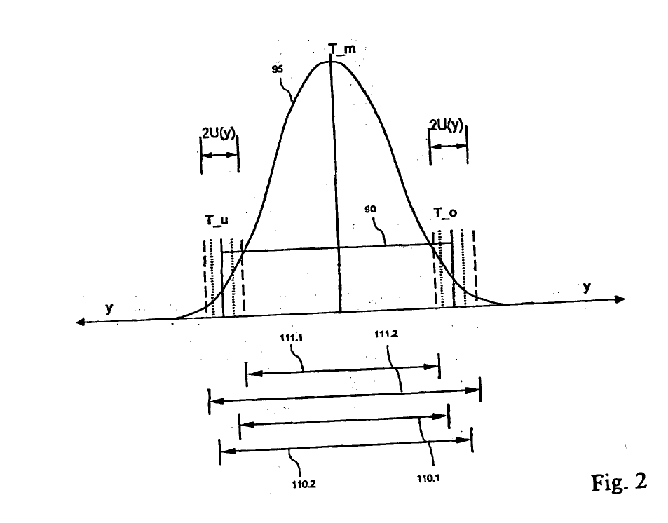

FIG. 2 illustrates the terms narrow and wide tolerance band for an influenced variable y. Represented on the one hand is a uniform distribution for the dispersion of the values of y which results from the variation of the parameters in the prescribed tolerances, and on the other hand a normal distribution for this fluctuation. The uniform distribution is represented by a horizontal line 90, the normal distribution by a bell-shaped curve 95. With the aid of a tolerance simulation, a resultant variation is determined for y. This is limited in the downward direction by T_u and in the upward direction by T_o. T_m is the value of y that is assumed if all the parameters have their desired value. A measuring inaccuracy U(y) was determined. The dashed lines illustrate the narrow tolerance band 111.1 and the wide tolerance band 111.2 in the case of uniform distribution. The dotted lines illustrate the narrow tolerance band 110.1 and the wide tolerance band 110.2 in the case of normal distribution.

The steps described up to now all belong to the generation phase. The classification phase is described below.

FIG. 1 shows the construction of a testing device which performs the method according to the present invention.

The vector u of the m input variables is fed to both the component part 10 as the object under test and the model 20 of the defect-free component part 10. The vector u brings about a variation over time of each of the n influenced variables. This vector y_actual of the variations over time is measured directly or indirectly, to be precise at the N sampling times t_l, . . . , t_N. A device for the direct and/or indirect measurement is not represented in FIG. 1.

With the aid of the model 20, n reference variations over time of the n influenced variables are calculated. In the process, the prescribed desired values are assigned to the model parameters, and the vector u of the m input variables is applied to the model 20. The model produces the reference variations for the n influenced variables.

Preferably, the actual variations and the reference variations are fed to a filter unit 30, which calculates smoothed actual variations over time y_actual_G and smoothed reference variations over time y_ref_G. The smoothed variations are fed to the classifier 40. This has reading access to a data memory 50 with the resultant variations of the n influenced variables for the N sampling times.

If the method is used for continuously monitoring the motor vehicle component part during operation, the vector u of the input variables is likewise measured while operation is in progress. If, as described above, it is used for quality control once for each copy of a component part, an activating vector u is specifically generated and, as shown in FIG. 1, applied both to the component part 10 to be tested and to the model 20.

The activating vector u is generated on the basis of the structural analysis described above. The test pattern stored in it is designed in such a way that all the operating points to be expected while operation is in progress and all the subsystems of the component part 10 are activated. For example, all the rotational speeds and prescribed driving settings occurring during a journey of the motor vehicle are run through. To save time, the test pattern is constructed in such a way that subsystems which are independent of one another, that is to say do not interact with one another, are tested at the same time. The degree of defect coverage, that is to say the quotient of the number of defects which can be detected on the component part by changing an influenced variable and the number of all possible defects on the component part, lies close to 1.

Preferably, the same activating vector u is used both in the generation phase to determine the resultant variations of the influenced variables and in the classification phase to generate the actual variations and reference variations over time. In the generation phase, the activating vector u acts as a vector of the variations over time of the m input variables. Re-use is possible in particular whenever the method according to the present invention is used for quality control or incoming goods control and the activating vector u is therefore freely selectable. In this case, the reference variations, dependent on the variation of the activating vector u, and the tolerance bands are preferably already generated in the generation phase.

It is possible that the influenced variables also include state variables, which are measured indirectly. In particular in the case of a linear model, a bank of observers can be used for this purpose. An indirectly measured variable may also be what is known as a residuum, that is a variable which is calculated as the difference between actual variations and desired variations and which ideally always assumes the value zero when the component part 10 is defect-free. Methods for constructing observer banks and residua are described for example in Th. H6fling: “Zustandsgrössenschätzung zur Fehlererkennung” [State variable estimation for defect detection], in: R. Isermann: “Überwachung und Fehlerdiagnose-Moderne Methoden und ihre Anwendungen bei technischen Systemen”, VDI-Verlag, 1994, pages 89-109.

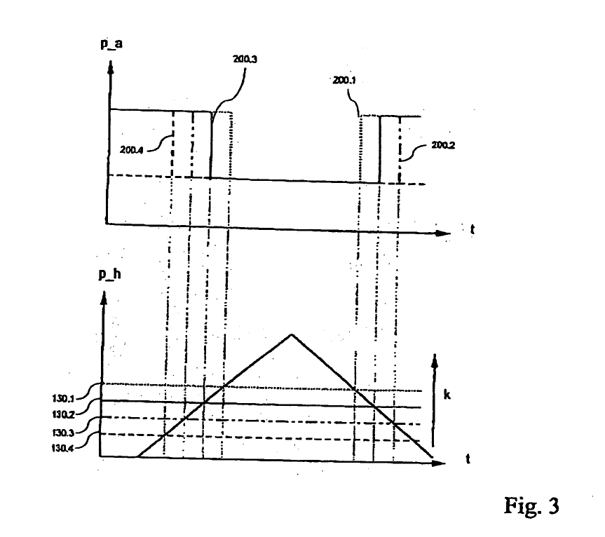

The example shown in FIG. 3 relates to a control valve, that is a component with a spring in a control plate in the automatic transmission. In FIG. 3, various variations of an influenced variable p_a are represented. The variation and the state of p_a depend inter alia on an internal event, which in turn is influenced by direct activation of the variable p_h (a pressure). A parameter k influences the switching threshold for the triggering of the internal event and depends on the spring. It is indirectly measured whether, and if so when, the internal event was triggered. In addition, the signal path of p_a and p_h is triggered. By the indirect measurement in combination with the evaluation of the activation, the current value of the parameter k is measured.

The control valve may be defect-free or have one of the following three defects: the spring is not present, its spring constant is too great, its spring constant is too small. Depending on the state of the spring, k assumes one of the four values which are represented in the lower diagram by four horizontal lines. The reference value k assumes the value 130.1 if the spring constant is too great. It assumes the value 130.2 if the component is defect-free, the value 130.3 .if the spring constant is too small, and the value 130.4 if the spring is missing.

The influenced variable p_h is compared with the reference value k. If p_h is greater than or equal to k, an internal event is triggered in the control plate. This reduces the value of p_a.

Once p_h is smaller than k again, and therefore the changeover condition is no longer satisfied, p_a is increased again to the old value.

If the component is defect-free, the variable p_a shows the reference variation 200.3. If a spring with a spring constant that is too large is fitted into the control valve, this is reflected in the deviating variation over time of p a. The value of p a is reduced too late, because the internal event is triggered too late (variation 200.1). If the installed spring has a spring constant that is too small, the value of p_a is reduced too early and increased too late (variation 200.2). If a spring has not been installed, the variation 200.4 results from this error. The measured value of p_a is not increased again at all, because there is no counteracting force to push the piston in the opposite direction when p_h is reduced.

The filter unit 30 smoothes short-term peaks in the raw measured-value variations y_actual and the reference variations y_ref. It also reduces the noise which is coupled in by the testing means, the testing process and/or the surroundings. For this purpose, the filter unit 30 stores the measured values and the calculated values for a number of sampling times. Preferably, the values of the last three to twenty sampling times are stored. Older values are continuously overwritten by new values.

The classifier 40 calculates from the resultant variations, which may vary from sampling time to sampling time, and the measuring inaccuracy for each influenced variable a wide tolerance band and a narrow tolerance band. The wide tolerance band and the narrow tolerance band are placed symmetrically around the respective smoothed reference variations. The width of the wide tolerance band at the sampling time t_k for the influenced variable y is var(y, t_k)+2*U(y), that of the narrow tolerance band var(y, t_k)−2*U(y). Here, var(y, t_k) denotes the resultant variation, calculated as described above, of y at the sampling time t_k and U(y) denotes the measuring inaccuracy for the measuring of y, which is likewise determined as described above.

Once the classifier 40 has generated the narrow tolerance band and the wide tolerance band for each influenced variable, it compares the smoothed actual variation over time y_actual G with the tolerance bands. Preferably, a variation over time of classification values which lie in the interval between 0 and 1 (inclusive) is generated in that a classification value is calculated at least for each sampling time. If after the smoothing the actual value at the sampling time t_k is in the narrow tolerance band, the classification value is 0. If it lies outside the wide tolerance band, an intolerable defect is present, and the classification value is 1. Otherwise, a value between 0 and 1 is calculated.

This classification value is a measure of the deviation from the narrow tolerance band and is used as a measure of the quality of the smoothed influenced variable y. The variations over time of the classification values are preferably combined in a defect vector e. The defect vector e is fed to a functional unit 60 for defect determination, the defect determinator. The defect determinator 60 evaluates the defect vector e and determines the defects which have occurred on the component part 10.

This defect determinator 60 preferably operates as follows: in the generation phase, a defect model is generated for each defect that is possible on the component part 10. This takes place by the model 20 for the component part 10 being changed in such a way that the modified model describes the behavior of the component part 10 when the possible defect is present. For example, model parameters are correspondingly modified, for example in that the value of a spring constant is changed. Or a structural changeover or change is made in the model. Relationships between defects and variations over time are automatically determined by simulations with the defect models for the possible defects.

In the classification phase, the measured variations are compared with the tolerance bands for the n influenced variables. The comparison is evaluated, in order to conclude automatically the defects that have actually occurred.

If a defect is detected, at least one component of the defect vector e assumes the value one. The point in time of the occurrence of the defect and the presence of an activation u at the n inputs of the technical system are determined and evaluated, in order to generate a statement about the signal path in which the defect has occurred. The fact that the signal path that is affected by a defect is detected means that the number of possible defective components of the technical system is restricted. If it is possible to measure at least a selected intermediate variable of the signal path that is affected by a defect and to form a defect vector for this variable, the defect vector of the intermediate variable is evaluated. If this defect vector is given the value zero, the set of components coming into question is further restricted, since the component that is affected by a defect lies in the part of the signal path between the intermediate variable and the output variable of the system. If it is given the value one, the component lies in the part of the signal path between the input and the measured intermediate variable of the signal path. To identify the component with its defect unequivocally, the defect models of the components coming into question are activated one after the other and the system behavior is simulated. A component defect is found when the defect vector e does not have a value of one in any component when the measured variations are compared with the variations which an activated defect model produces.

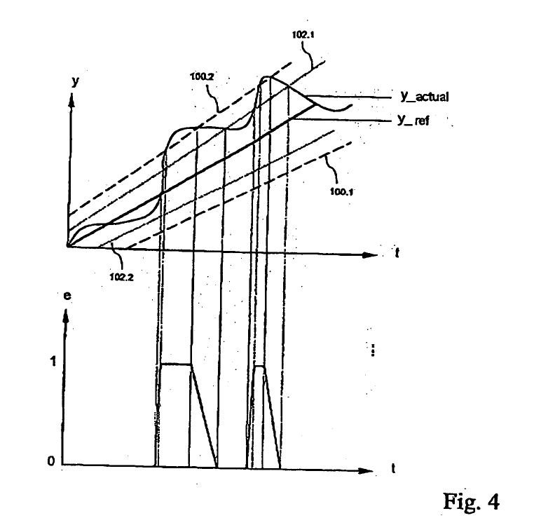

FIG. 4 shows an example of the effect of a parameter drift on an influenced variable. In FIG. 4, the comparison between an actual variation and a reference variation is illustrated. In the upper diagram, the reference variation y_ref of the influenced variable y is shown by a solid straight line. The wide tolerance band is represented by two dashed lines 100.1 and 100.2, the narrow tolerance band by two dotted lines 102.1 and 102.2. A sinuous line is measured as the actual variation over time y_actual. In the lower diagram, the result of the defect detection is shown, namely the component of the defect vector e which relates to the influenced variable y. It is shown at which points in time which classification values are calculated.

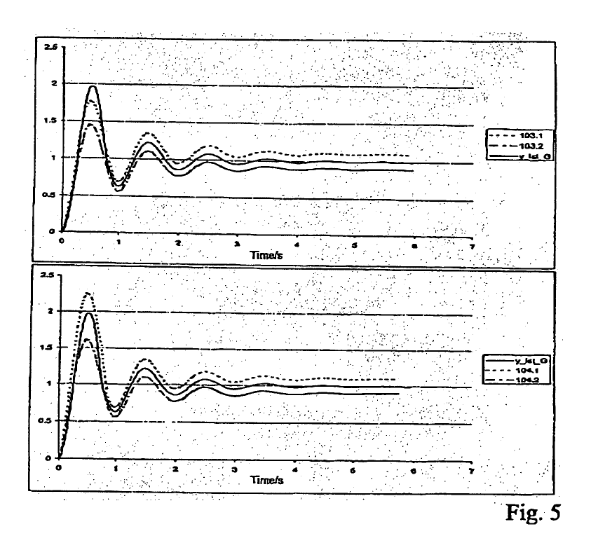

In FIG. 5—it is shown how the classifier 40 has adapted to overshooting by adaptation of a wide tolerance band. In the upper diagram, a smoothed variation over time of an influenced variable y_actual_G and a wide tolerance band around a smoothed reference variation y_ref G are shown. The two limits 103.1 and 103.2 of the wide tolerance band are shown by dashed lines.

As shown in the upper diagram in FIG. 5, the actual variation lies in the range of 0.3 sec<t<0.6 sec outside the wide tolerance band. In this example, this departure from the wide tolerance band is not assessed as a defect, but as admissible overshooting during the transition from a steady-state value to another value. If this overshooting was not already taken into account in the determination of the resultant variation during the generation phase, it is taken into account in the classification phase, in that the limits 103.1 and 103.2 of the wide tolerance band are adapted. The lower diagram of FIG. 5 shows the wider tolerance band adapted in the range 0<t<0.9 sec, with the limits 104.1 and 104.2. The actual variation y_actual_G lies within these adapted limits.

Preferably, the wide tolerance band is adapted as follows: its width is changed by multiplication by a factor b(t). During an adaptation time period, b(t)>1, otherwise b(t)=1. One embodiment provides that b(t) is defined in the adaptation time period by the following calculating rule:

$$b ( t ) = A \cdot \sqrt{\frac{t}{T}} ( \frac{1}{1 + \frac{t}{T}} ) ,$$

where T is a prescribed point in time at which b(t) has its maximum. A is a constant which ensures that the absolute value of b is greater than 1 and T is the point in time at which the function has its maximum. As a result, the tolerance band is spread at its widest in T.

The example of FIG. 3 is discussed again below. The control plate comprises a continuous-value component with the influenced variable p_a and a discrete-value component with the directly measured variable p_h. In the classification phase, the inputs of the continuous-value component are stimulated with a staircase-shaped excitation and those of the discrete-value component are stimulated with a triangular or trapezoidal signal. In this case, the rate of rise of the leading and trailing edges of the excitation signal is to be made to match the system dynamics. Owing to the interaction between the two components, the switching operation has an effect on the state of the continuous-value component.

For testing and defect detection on the control plate, two counters are used. The first counter is started with the beginning of the testing process and is stopped on the basis of the trailing edge of the signal p_a according to FIG. 3. The second counter is started with the trailing edge of the signal p_a and is stopped with the rising edge of the signal p_a. The counter value N_start of the first counter is compared with the counter reference value N_start_ref. The counter value N_actual of the second counter is compared with the counter reference value N_ref. Depending on the result of the comparison, the defects according to the following table are detected. For unequivocal distinction between the defect case “no spring” and the defect case “spring constant too small”, a third value N_limit is introduced. It is included in the evaluation and is used for stopping the counters.

A distinction is made between two cases in which the spring is missing. In the first case, the piston of the control valve (discrete-value component) is in such a position that the piston is pushed into the opposed end position by a pressure increase of p_h and the internal event is triggered. The triggered internal event has the consequence of a pressure reduction of p_a. The step-shaped pressure reduction of p_a cannot be reversed by lowering p_h, since the counteracting force of the spring to bring the piston of the control valve into the opposed end position is missing, compare line 200.4 in FIG. 3.

In the second case, the piston of the control valve is in such a position that the internal event is already triggered without a controlling effect of p_h. The pressure p_a is reduced. A pressure increase of p_a by a controlling effect of p_h is not possible.

In the first case, the second counter is stopped automatically when N_limit is reached. In the second case, the first counter is stopped automatically when N_start=N_limit is reached.

| | Value comparison of | Value comparison of |
|---|---|---|
| Defect | counter 1 | counter 2 |
| Spring | N_start = N_start_ref | N_actual = N_ref |
| constant | | |
| normal | | |
| Spring | N_start > N_start_ref | N_actual < N_ref |
| constant | | |
| too | | |
| great | | |
| Spring | N_start < N_start_ref | N_actual > N_ref |
| constant | | |
| too | | |
| small | | |
| No | N_start < N_start_ref | N_actual = |
| spring: | | N_limit > N_ref |
| 1^{st} case | | |
| No | N_start = N_limit > N_start_ref | N_actual = 0 < N_ref |
| spring: | | |
| 2^{nd} case | | |

1. A method for automatically monitoring a technical system, the method comprising:
feeding an input variable into the technical system, the input variable varying over time;
measuring a variation over time of at least one influenced variable being influenced by the technical system so as to determine a measured influenced variable variation;
feeding the input variable is into an automatically evaluatable model describing a relationship between the influenced variable and the input variable in a defect-free state of the technical system;
calculating a reference variation over time of the influenced variable using the model;
prescribing a parameter tolerance for at least one parameter of the model;
prescribing an input variation over time of the input variable;
determining a measuring inaccuracy for measuring the influenced variable;
varying the parameter within the parameter tolerance, stimulating the model with the input variation;
calculating a plurality of calculated influenced variable variations resulting from the parameter variation using the stimulated model;
determining a resultant influenced variable variation using the plurality of influenced variable variations;
determining a narrow tolerance band and a wide tolerance band around the reference variation, the narrow tolerance band having a narrow width equal to the resultant influenced variable variation reduced by twice the measuring inaccuracy, and the wide tolerance band having a wide width being equal to the resultant influenced variable variation increased by twice the measuring inaccuracy;
comparing the measured influenced variable variation with the reference variation;
classifying the technical system as defect-free if the measured influenced variable variation always lies within the narrow tolerance band; and
classifying the technical system as defective if the measured influenced variable variation lies outside the wide tolerance band at least for a time.

2. The method as recited in claim 1, wherein the prescribing the parameter tolerance includes respectively prescribing a plurality of parameter tolerances for a plurality of parameters of the model, wherein the varying of the parameter includes determining a smallest and a greatest value for each of the plurality of parameters lying within a respective one of the plurality of parameter tolerances, and wherein the calculating of the plurality of calculated influenced variable variations includes calculating a calculated influenced variable variation over time for each respective combination of smallest and/or greatest values.

3. The method as recited in claim 1, wherein the measuring of a variation over time of at least one influenced variable includes measuring a plurality of respective variations over time of a plurality of influenced variables so as to determine a plurality of measured influenced variable variations, wherein the model describes the relationship between each of the plurality of influenced variables and the input variable, wherein the calculating of the reference variable includes calculating a plurality of respective reference variables of each of the plurality of influenced variables, wherein the placing of tolerance bands includes placing a narrow tolerance band and a wide tolerance band around each of the plurality of reference variations, wherein the comparing includes comparing each of the measured influenced variable variations with a respective one of the plurality of narrow and wide tolerance bands, wherein the technical system is classified as defect-free if each of the measured influenced variable variations lies within the respective narrow tolerance band, and wherein the technical system is classified as defective if at least one of the measured influenced variable variations lies outside the respective wide tolerance band at least for a time.

4. The method as recited in claim 3, further comprising:
determining a plurality of relationships between a plurality of possible defects of the technical system and an effect of each of the possible defects on the respective plurality of influenced variable variations; and
evaluating comparisons between the plurality of measured influenced variable variations and the respective tolerance bands of the influenced variables so as to determine an actual defect occurring on the technical system.

5. The method as recited in claim 4, further comprising:
prescribing a defect model for each possible defect describing a relationship between the influenced variables and the input variable when the possible defect is present on the technical system; and
performing simulations with the defect models so as to determine relationships between possible defects and variations over time.

6. The method as recited in claim 5, wherein the defect models are prescribed by an automatic changing of the model for the defect-free technical system.

7. The method as recited in claim 1, further comprising:
determining a time period for monitoring the technical system;
determining a number of sampling times in the monitoring time period, wherein the measured influenced variable variation and the reference variation include values at respective sampling times; and
calculating a resultant influenced variable variation of the influenced variable for each sampling time using parameter variation, and
wherein the narrow tolerance band is placed around the reference variable in such a way that, at each sampling time, the width of the narrow tolerance band is equal to the difference between the resultant variation at the sampling time and twice the measuring inaccuracy, and
wherein the wide tolerance band is placed around the reference variation in such a way that, at each sampling time, the width of the wide tolerance band is equal to the sum of the resultant variation at this sampling time and twice the measuring inaccuracy.

8. The method as recited in claim 1, wherein, if the measured influenced variable variation lies outside the narrow tolerance band and within the wide tolerance band, performing at least one of the following steps:
classifying the technical system as defect-free;
classifying the technical system as defective and restricting a use of the technical system;
investigating the technical system; and
determining an extent to which the portion of the measured influenced variable variation lies outside the narrow tolerance band and classifying the technical system as one of a plurality of possible quality classes according to the extent.

9. A computer-program product loadable directly into an internal memory of a computer and having software sections configured to perform the method as recited in claim 1 when the product is running on a computer.

10. A computer-program product stored on a computer-readable medium and including a program means readable by a computer configured to make the computer perform the method as recited in claim 1.
